(19) United States
(12) Patent Application Publication
(10) Pub. No.: US 2020/0357567 A1
(43) Pub. Date: Nov. 12, 2020

(54) METHOD FOR PRODUCING SPACERS FOR A WINDING UNIT AND VOLTAGE-RESISTANT SPACERS FOR CAST RESIN TRANSFORMERS

(71) Applicant: SIEMENS AKTIENGESELLSCHAFT, MUENCHEN (DE)

(72) Inventors: ANDRE LUIZ MORENO, VARZEA PAULISTA (BR); MARTIN ALSINA NAVARRO, JUNDIAI (BR); RICHARD SILLE, KIRCHHEIM (DE)

(21) Appl. No.: 16/765,948

(22) PCT Filed: Oct. 24, 2018
(86) PCT No.: PCT/EP2018/079123

§ 371 Date: May 21, 2020

(30) Foreign Application Priority Data
Nov. 21, 2017 (DE) 10 2017 220 781

(51) Int. Cl. H01F 27/32; H01F 41/12; B29C 48/28; B29C 48/91; B29C 39/42; B29C 39/38

(52) U.S. Cl. CPC H01F 27/327; H01F 41/127; B29C 48/28; B29L 2031/3412; B29C 39/42; B29C 39/38; B29C 2791/006; B29C 48/91

(57) ABSTRACT

In a cost-effective and qualitatively better method for producing spacers for a winding unit of an electrical high-voltage device, at least two starting components are mixed together in a mixing chamber under vacuum to form a component mixture. The component mixture is transferred to an extrusion housing, likewise under vacuum, of an extruder in which a transport device is arranged and which is equipped with a mouthpiece delimiting an outlet opening. The extrudate exiting from the mouthpiece is cured by the addition of heat in a vacuum in order to obtain the spacers.

The invention relates to a method for producing spacers for a winding unit of an electrical high-voltage device.

An electrical high-voltage device is known from EP 2433289 B1. Herein, a “dry type transformer” is described, having a winding unit equipped with two windings which are arranged concentrically to one another. The two windings are mutually inductively connected by means of a magnetizable iron core, wherein the external winding is rated for higher voltages, and is consequently described as the higher-voltage winding. An input voltage which is applied to the higher-voltage winding generates an induction current, which induces an output voltage on the lower-voltage winding which, inter alia, is dependent upon the ratio of turns between the higher- and lower-voltage windings. For the electrical insulation of the windings, the latter are arranged in a solid insulating body of a cured polymer such as, for example, epoxy resin.

In the production of the known winding unit, the windings are firstly positioned in relation to one another by the employment of “spacers”, and are then encapsulated in a liquid resin. In order to prevent any inclusion of moisture or air in the insulating body, the casting and curing of said insulating body proceeds in a vacuum kiln. During casting, the spacers remain in the liquid resin, and consequently form a constituent element of the winding body further to the curing of the resin. It is therefore essential for the dielectric strength of the winding body that the spacers should also be constituted free from any inclusion of air, as a risk of a partial discharge would otherwise be present which would drastically reduce the dielectric strength of the winding body.

It is therefore customary for spacers to be likewise produced by mold casting under a vacuum. However, this production process is complex, particularly on the grounds of the comparatively high part number of spacers required within a winding unit.

The object of the invention is therefore the provision of a method of the above-mentioned type which is simple and cost-effective.

According to the invention, this object is fulfilled by a method of the above-mentioned type, wherein at least two starting components are mixed together in a mixing chamber under a vacuum to form a component mixture. The component mixture is transferred to an extrusion housing of an extruder, which is likewise under a vacuum, in which a transport means is arranged, and which is equipped with a mouthpiece which delimits an outlet opening. Extrudate exiting from the mouthpiece is cured by the application of heat in a vacuum, in order to obtain the spacers.

According to the invention, a method for producing spacers is provided which is cost-effective, and is simultaneously suitable for mass-production. The production method is virtually exclusively executed in a vacuum, such that the spacers can be produced with no inclusion of air and free from any moisture. In the context of the invention, an extruder is employed, having an extrusion housing with a mouthpiece which delimits an appropriately configured outlet opening. Within the extrusion housing, a transport means is arranged which compresses the moldable component mixture through an outlet opening of the mouthpiece. The exiting, for example cordlike, extrudate can be cut to form the desired finished spacers by means of an appropriate cutting tool. By way of deviation, preformed and cured elements of the component mixture are present in the extrusion housing, such that cutting is not absolutely necessary.

As described above, the extrudate which is arranged in the extrusion housing is still moldable. For example, the extrudate in the extrusion housing is still liquid. By way of deviation, the component mixture can already be partially cured. The component mixture, for example, thus comprises monomers which have already reacted with other monomers, and monomers which have not done so as yet. Naturally, it is also possible for the monomers employed to comprise a plurality of reaction sites, wherein not all the reaction sites have reacted as yet. In other words, polymerization is not yet complete. In this manner, the extrudate, which assumes a “B state”, retains its moldability.

As a transport means for the compression of the extrudate out of the extrusion housing, any conveyor means, for example a worm screw or a piston, can be considered.

The employment of an, in principle, known extrusion method for the production of spacers in the field of high-voltage devices is unusual, to the extent that it is also possible for the insulating body, in which the spacers are encapsulated subsequently, not to be produced by such a method. The production of a spacer by means of an extrusion method in a vacuum, wherein the spacer is subsequently arranged in an insulating body which is produced by mold casting, is not obvious. The invention permits production costs for the spacer, and thus for the entire winding unit, to be drastically reduced.

According to the invention, the exiting extrudate is heated under a vacuum. By means of heating, polymerization is completed.

According to an advantageous further development of the invention, for example, a heating element in the form of a heating kiln is arranged down-circuit of the extrusion housing, by means of which, for example, the cordlike component mixture exiting the extruder undergoes heat-up, such that the polymerization of the component mixture is initiated or completed. Reaction ultimately proceeds at free reaction sites, such that the desired mesh structure of the polymer is constituted.

According to an appropriate further development with respect hereto, the component mixture, prior to the transfer thereof to the extrusion housing, is partially cured in a mold. In the context of the invention, as mentioned above, it is also possible for the component mixture to be cured wherein, either by the appropriate selection of components or by the addition of a chemical catalyst, the polymerization process is initiated. Thus, for example, component A is a monomer, the polymerization of which can be initiated by the addition of a further component B. The reaction proceeds until such time as a “B state” of the component mixture has been achieved, in which the component mixture has achieved a degree of solidity, but is still susceptible to deformation by the extruder.

The component mixture, for example, can thus be cured in a mold or a casting element, and the resulting shaped part is then introduced into the extruder, the transport means of which then compress the cured shaped part through the outlet opening, as a result of which the desired shape is imposed upon the component mixture or the extrudate. Complete curing is achieved by the application of heat in a vacuum.

Appropriately, after cutting, spacers are stored under a vacuum at a predefined curing temperature for a predefined time period. In this manner, it is further ensured that any inclusion of air in the spacers is prevented. Storage under a vacuum can be executed in appropriate storage spaces which are arranged, for example, down-circuit of a cutting unit. A vacuum is applied to the storage chamber.

Advantageously, the starting components, prior to the mixing thereof, are transferred to a component housing, in which a vacuum is then applied, wherein each component housing is connected, on the output side, to a mixing chamber. From the component housing, the components enter a mixing chamber which is equipped, for example, with stirring or mixing tools, in order to ensure the optimum mixing of components. From the mixing chamber, the component mixture finally enters the extrusion housing, out of which the mixture is compressed through the mouthpiece by the transport means.

The invention further relates to a winding unit for an electrical high-voltage device which is configured, for example, as a high-voltage choke coil or as a high-voltage transformer. As mentioned above, the winding unit comprises at least one winding, wherein winding conductors of the winding are at least partially maintained in the desired position by means of the above-mentioned spacers. Winding conductors, for example, can be maintained at a distance from one another in the radial, axial or longitudinal direction of the winding by means of comb-shaped spacers.

Naturally, in the context of the invention, it is also possible for the winding unit to comprise at least two hollow cylindrical windings, which are arranged concentrically in relation to one another. The function of the spacers is the orientation of the windings in relation to one another, before the latter are encapsulated in liquid insulating means. Encapsulation proceeds in an appropriate mold within a vacuum kiln, such that any inclusion of air is again prevented. The vacuum also ensures that the insulation of the winding conductors remains free of moisture.

According to a preferred configuration of the invention, the winding unit comprises a higher-voltage winding and a lower-voltage winding which are arranged concentrically in relation to one another, wherein the spacers at least partially extend between the lower-voltage and higher-voltage windings. In this manner, the concentric orientation of the windings during encapsulation is permitted.

It is moreover advantageous if the spacers and the insulating body are formed of the same material.

Further appropriate configurations and advantages of the invention are the subject matter of the following description of exemplary embodiments of the invention, with reference to the figures of the drawing, wherein identically functioning components are identified by the same reference numbers, and wherein:

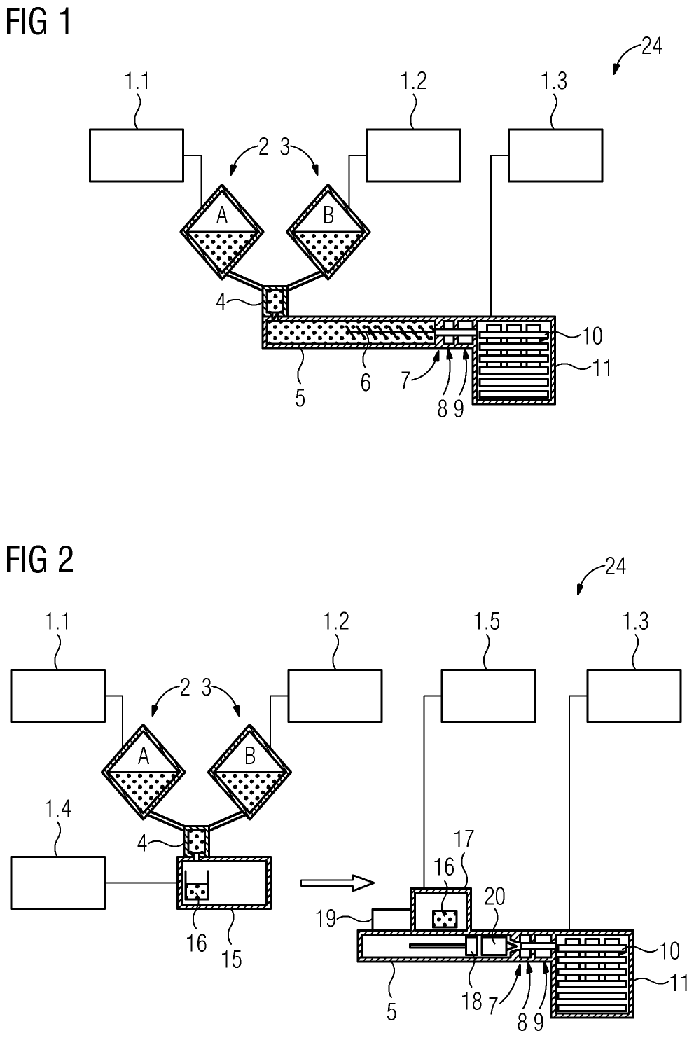

FIG. 1 shows a schematic illustration of a first exemplary embodiment of the method according to the invention,

FIG. 2 shows a schematic representation of a further exemplary embodiment of the method according to the invention,

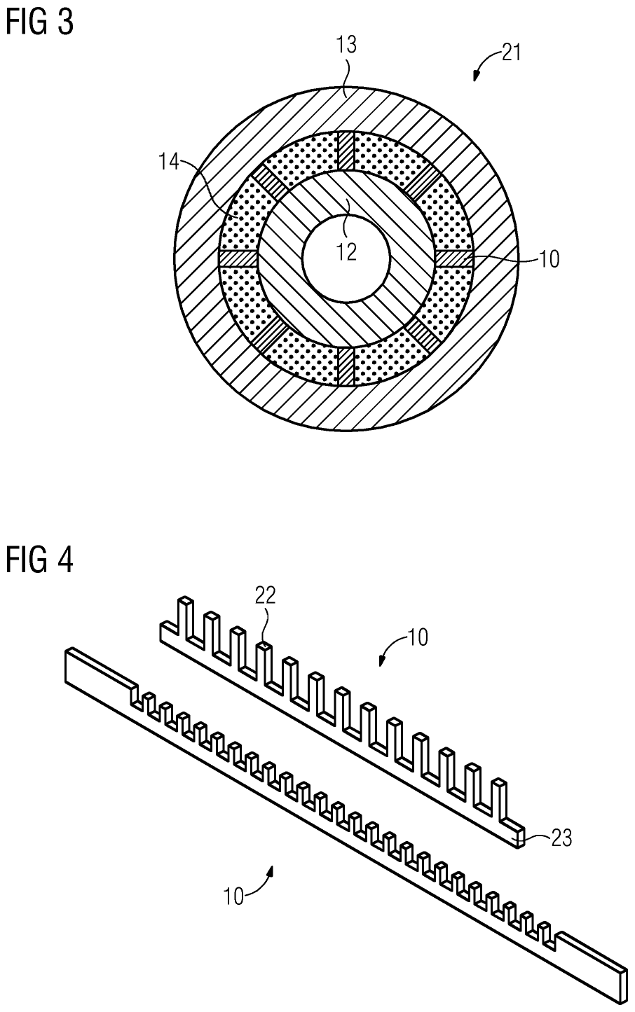

FIG. 3 shows a schematic overhead view of an exemplary embodiment of a winding unit according to the invention, and

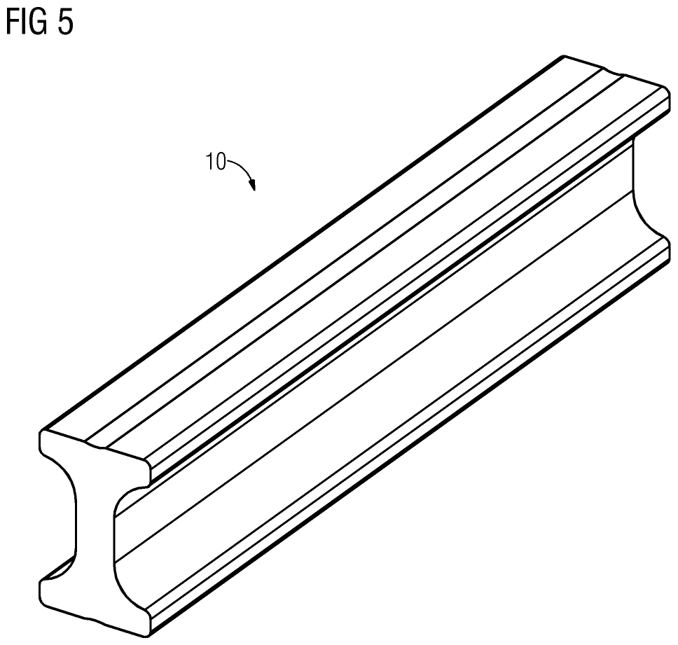

FIGS. 4 and 5 show exemplary embodiments of spacers produced according to the invention.

FIG. 1 shows an apparatus 24 for executing a variant of the method according to the invention. Firstly, two components A and B are respectively dispensed into a component housing 2 or 3. Thereafter, by means of a vacuum apparatus 1.1 and a vacuum apparatus 1.2, a vacuum is generated in each component housing 2 or 3. In other words, air which initially occupies the gas space above the liquid component A is extracted until a gas pressure below 10 mbar is achieved. The vacuum apparatuses 1.1 and 1.2 comprise a vacuum pump. If the latter is shut down, a temperature-dependent vapor pressure equilibrium of component A or component B is established. Moisture, and particularly air, is removed from the component housings 2 and 3. Thereafter, by means of the feed lines represented, components A and B are transferred to a mixing chamber 4 equipped with an appropriate stirring tool, which is not diagrammatically represented. In the mixing chamber, components A and B are mixed together to constitute a component mixture.

The component mixture passes from the mixing chamber 4 into an extrusion housing 5 of an extruder, in which a vacuum likewise prevails. In the extrusion housing 5, a transport means in the form of a worm screw 6 is arranged, which assumes a rotary motion by means of an electrical drive unit which is not diagrammatically represented. The component mixture which is located in the extrusion housing 5 is thus compressed through an outlet opening of a mouthpiece 7, which is not diagrammatically represented, and is arranged at the end of the extrusion housing 5 which is averted from the mixing chamber 4. The extrusion housing 5 extends in a longitudinal direction and is configured with a hollow interior.

Extrudate exiting the mouthpiece 7 then undergoes heat-up in the interior of a heating element 8, such that the polymerization of the component mixture is compelled to progress further, and the component mixture is virtually fully cured. Naturally, a vacuum also prevails in the interior of the heating element 8. Extrudate exiting the mouthpiece 7 is configured with a cordlike shape. A cutting unit 9 is therefore arranged down-circuit of the heating element 8, which cuts the cordlike material into the desired spacers 10, under a vacuum. The spacers 10 are then stored in a storage chamber 11 for a predefined time period, for example two hours, at a temperature of the order of 20 to 80 degrees. A vacuum is applied to the storage chamber 11 by means of the vacuum apparatus 1.3.

FIG. 2 illustrates a further variant of the method according to the invention. Here again, two components A and B are dispensed into a component housing 2 or 3, wherein a vacuum is again applied to the component housings 2 and 3 by means of the vacuum apparatus 1.1 or 1.2. In this manner, any air present is removed until the gas space above the liquid components is virtually entirely filled with the gaseous component A or B. Components A and B are again mixed together in the mixing chamber 4, from whence, in the liquid state, the mixture enters a mold 16, which is arranged on a curing chamber 15. A vacuum is applied to the curing chamber 15 by means of the vacuum apparatus 1.4. Optionally, the curing chamber is equipped with a heating element, the setting of which is such that the component mixture arranged in the mold 15 is converted to a “B state”, in which the component mixture assumes a degree of solidity, but is still susceptible to deformation by the extruder.

The cured component mixture, in the B state, is then transferred to an intake chamber 17, to which a vacuum is again applied by means of the vacuum apparatus 1.5. The intake chamber 17 is connected to the extrusion housing 5 of the extruder by means of a connecting line 19. In other words, a vacuum is also applied to the extrusion housing 5. As a transport means 18, in this case, an extrusion piston is provided, which compresses the component mixture block which is introduced from the intake chamber 17 into the extrusion housing 5 or, in other words, the preformed component mixture in the B state, through the outlet opening 20 of the mouthpiece 7.

Extrudate exiting the mouthpiece 7 again undergoes heat-up by means of a heating element 8, and is thus further cured, wherein, by means of an appropriate cutting tool 9, the desired spacers 10 are delivered, which are stored in a storage chamber 11 for a predefined time period at a predefined temperature. An appropriate vacuum is generated in the storage chamber 11 by means of the vacuum apparatus 1.3.

FIG. 3 shows an exemplary embodiment of a winding body 21 according to the invention, which comprises an annular lower-voltage winding 12, and a higher-voltage winding 13 which encloses the full circumference of the latter. The lower-voltage winding 12 and the higher-voltage winding 13 are arranged concentrically in relation to one another. To this end, the lower- and higher-voltage windings 12 and 13 are encapsulated in an insulating material, for example a resin, in a liquid state. The insulating material 14 is then cured in a vacuum kiln. In order to maintain the mutually concentric arrangement of the lower- and higher-voltage windings 12 and 13 during encapsulation, spacers 10 are provided, which extend in a radiating pattern or radially between the lower- and higher- voltage windings 12 and 13.

FIG. 4 shows an exemplary embodiment of a spacer 10 produced by the method according to the invention which, in the exemplary embodiment represented in FIG. 4, constitutes a “comb structure”, in which separate limbs 22 project from a common web 23. The winding conductors of a winding layer can thus be accommodated between the limbs 22. By means of the web 23, winding layers which are arranged one on top of another are spaced from one another in the longitudinal direction.

FIG. 5 shows a further exemplary embodiment of a spacer 10 prior to cutting, which is configured with an “I-profile”.

1-10. (canceled)

11. A method for producing spacers for a winding unit of an electrical high-voltage device, which comprises the steps of:
mixing at least two starting components together in a mixing chamber under a vacuum to form a component mixture;
transferring the component mixture to an extrusion housing of an extruder likewise being under vacuum, and in the extruder a transport means is disposed and equipped with a mouthpiece delimiting an outlet opening; and
curing extrudate exiting from the mouthpiece by an application of heat in a vacuum, in order to obtain the spacers.

12. The method according to claim 11, wherein the extrudate exiting the extruder undergoes heating-up under vacuum by means of a heater which is disposed downstream of the extruder.

13. The method according to claim 11, wherein the component mixture, prior to a transfer thereof to the extrusion housing, is partially activated in a mold.

14. The method according to claim 13, which further comprises storing the spacers under vacuum at a predefined curing temperature for a predefined time period.

15. The method according to claim 11, which further comprises transferring the starting components, prior to the mixing thereof, to an associated component housing, and in the component housing a vacuum is applied, wherein each said component housing is connected, on an output side, to the mixing chamber.

16. The method according to claim 11, which further comprises cutting the extrudate exiting the mouthpiece into the spacers by means of a cutting tool under vacuum.

17. A winding unit for an electrical high-voltage device, the winding unit comprising:
at least one winding; and
spacers, said spacers being formed by:
mixing at least two starting components together in a mixing chamber under a vacuum to form a component mixture;
transferring the component mixture to an extrusion housing of an extruder likewise also being under vacuum, and in the extruder a transport means is disposed and equipped with a mouthpiece delimiting an outlet opening; and
curing extrudate exiting from the mouthpiece by an application of heat in vacuum, in order to obtain the spacers.

18. The winding unit according to claim 17, wherein:
said winding unit has a higher-voltage winding and a lower-voltage winding, which are disposed concentrically in relation to one another; and
said spacers extend between said higher-voltage winding and said lower-voltage winding.

19. The winding unit according to claim 18, further comprising a casting compound, said spacers are encapsulated in said casting compound.

20. The winding unit according to claim 19, wherein each of said spacers and said casting compound are produced from a same insulating material.
